(19) United States
(12) Patent Application Publication
(10) Pub. No.: US 2017/0091601 A1
(43) Pub. Date: Mar. 30, 2017

(54) CONTROL DEVICE, IMAGE FORMING APPARATUS, AND CONTROL METHOD

(71) Applicant: FUJI XEROX CO., LTD., Tokyo (JP)

(72) Inventor: Yasuaki MITOBE, Yokohama-shi (JP)

(73) Assignee: FUJI XEROX CO., LTD., Tokyo (JP)

(21) Appl. No.: 14/990,103

(22) Filed: Jan. 7, 2016

(30) Foreign Application Priority Data
Sep. 24, 2015 (JP) 2015-187298

(51) Int. Cl. G06K 15/00; G06K 15/12; G06F 3/06

(52) U.S. Cl. CPC G06K 15/402; G06F 3/065; G06F 3/0619; G06F 3/0685; G06K 15/12; G06K 15/401

(57) ABSTRACT

A control device includes: a first controller that includes a first memory configured to store data on control of plural devices connected to the first controller, and a recognizing unit configured to recognize the first memory as plural blocks each of which contains data of at least one of the plural devices; and a second controller that includes a processing unit configured to perform processing for controlling the plural devices, a requesting unit configured to designate a block for the first controller and request the first controller to read data, and a second memory configured to store the data of the block, the data being received from the first controller.

### CROSS REFERENCE TO RELATED APPLICATION

This application is based on and claims priority under 35 USC §119 from Japanese Patent Application No. 2015-187298 filed Sep. 24, 2015.

### BACKGROUND

Technical Field

The present invention relates to a control device, an image forming apparatus, and a control method.

Related Art

There exists a control device having apparatus controllers that control plural apparatus and a main controller that controls the apparatus controllers.

### SUMMARY

According to an aspect of the present invention, there is provided a control device including: a first controller that includes a first memory configured to store data on control of plural devices connected to the first controller, and a recognizing unit configured to recognize the first memory as plural blocks each of which contains data of at least one of the plural devices; and a second controller that includes a processing unit configured to perform processing for controlling the plural devices, a requesting unit configured to designate a block for the first controller and request the first controller to read data, and a second memory configured to store the data of the block, the data being received from the first controller.

### BRIEF DESCRIPTION OF THE DRAWINGS

Exemplary embodiments of the present invention will be described in detail based on the following figures, wherein:

FIG. 1 is a diagram illustrating an entire configuration of an image forming apparatus;

FIG. 2 is a diagram illustrating the configuration of the main-side transmitting and receiving unit in the main controller;

FIG. 3 is a diagram illustrating a configuration of the sub-side transmitting and receiving unit in the sub controller;

FIG. 4 is a sequence chart for describing the procedure of the copy processing to the copy register group;

FIGS. 5A to 5F are diagrams illustrating one example of data supply and data reception between the main controller and the sub controller in the copy processing to the copy register group;

FIGS. 6A to 6C are diagrams illustrating transition of the memory contents of the copy register group in the main controller, as an example of the copy processing shown in FIGS. 5A to 5F;

FIGS. 7A to 7E are diagrams illustrating transition of the memory contents of the copy register group from the time after the data storage on the basis of the first block transmission data to the time after the data storage on the basis of the second block transmission data, in one example of the copy processing shown in FIGS. 5A to 5F; and

FIGS. 8A to 8E are diagrams illustrating transition of the memory contents of the copy register group from the time after the data storage on the basis of the second block transmission data to the time after the data storage on the basis of the third block transmission data, in one example of the copy processing shown in FIGS. 5A to 5F.

### DETAILED DESCRIPTION

Hereinafter, an exemplary embodiment of the present invention will be described in detail with reference to attached drawings.

### [Configuration of Image Forming Apparatus]

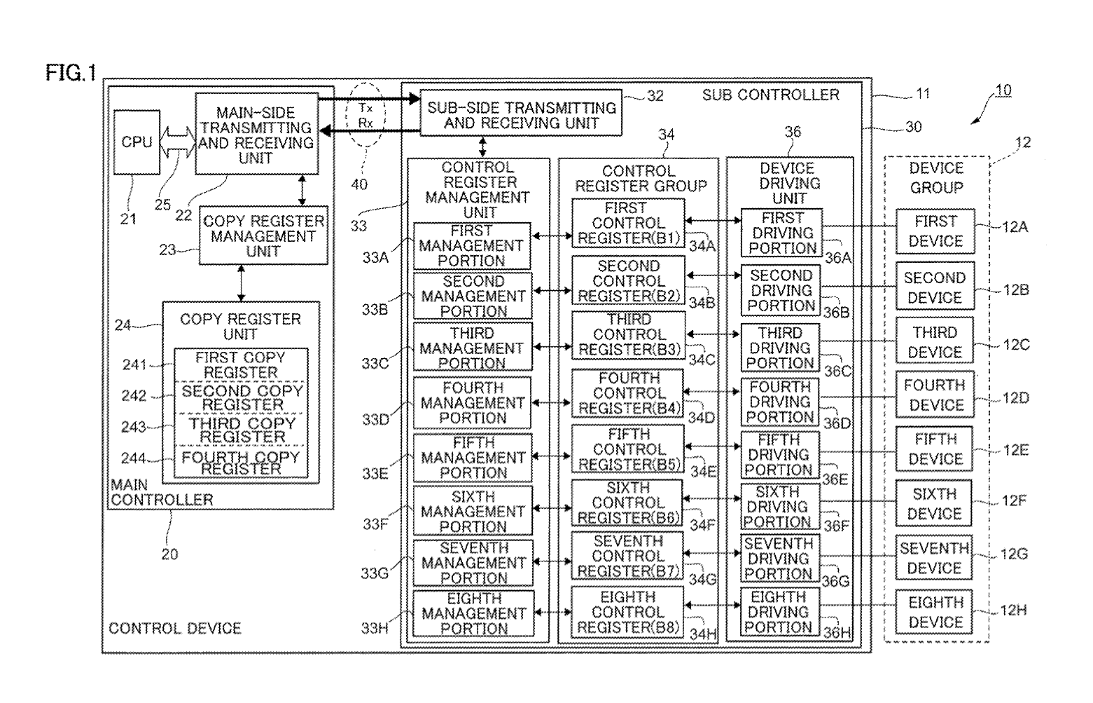

FIG. 1 is a diagram illustrating an entire configuration of an image forming apparatus 10 to which the exemplary embodiment is applied. In the exemplary embodiment, description will be given for the image forming apparatus 10 using an electrophotographic method, as an example. However, the method is not limited to this, and an ink-jet method or the like may be used.

The image forming apparatus 10 includes a control device 11, and a device group 12 that is used in image forming operation by the electrophotographic method, and that is a target controlled by the control device 11. In this example, the device group 12 is assumed to include eight devices (which are referred to as a first device 12A to an eighth device 12H). The first device 12A to the eighth device 12H are configured by various kinds of motors (configured to rotatably drive a photoconductor drum, an intermediate transfer belt, a transportation belt, a fixing roll and the like) used in the image forming apparatus 10, sensors (configured to detect temperature, humidity, light, existence of sheets, rotation of a rotator and the like), and so on. Note that, the number of devices of the device group 12 is not limited to eight, and is changed according to the type of the image forming apparatus 10.

The control device 11 of the image forming apparatus 10 includes a main controller 20 that controls overall operation of the image forming apparatus 10, a sub controller 30 that individually controls devices of the device group 12 of the image forming apparatus 10 under the control of the main controller 20, and a transmitting and receiving bus 40 that connects the main controller 20 and the sub controller 30, and transmits and receives data between them. Here, the main controller 20 and the sub controller 30 in the exemplary embodiment have a so-called “master-slave” relation.

(Configuration of Main Controller)

First, the main controller 20 as one example of a second controller includes a CPU 21, a main-side transmitting and receiving unit 22, a copy register management unit 23, a copy register group 24, and a CPU bus 25. Here, the main controller 20 of the exemplary embodiment is configured by hardware such as the Application Specific Integrated Circuit (ASIC) or the Field Programmable Gate Array (FPGA).

The CPU 21 as one example of a processing unit and a requesting unit controls overall operation of the image forming apparatus 10 through reading and executing a program stored in a non-volatile memory not shown in the figure. Note that the memory configured to store the program executed by the CPU 21 may be a rotatable memory medium such as a Hard Disc Drive (HDD), a flexible disc, a DVD disc, and a magneto-optical disc, a fixed-type memory medium such as a memory card and a Universal Serial Bus (USB) memory, or a memory medium of another device connected through a communication interface not shown in the figure.

The main-side transmitting and receiving unit 22 is configured by a so-called SERializer/DESerializer (SERDES) functioning as a serializer that converts parallel signals to serial signals and a deserializer that converts serial signals to parallel signals. When receiving data (parallel signals) to be transmitted to the sub controller 30, from the CPU 21 through the CPU bus 25, the main-side transmitting and receiving unit 22 packetizes the parallel signals, converts the packets into serial signals, and transmits the converted packets in serial form to the sub controller 30 through the transmitting and receiving bus 40. In addition, when receiving a packet in serial form from the sub controller 30 through the transmitting and receiving bus 40, the main-side transmitting and receiving unit 22 converts the received packet into a packet in parallel form, and decodes the packet in parallel form, and extracts data included in the packet.

The copy register management unit 23 provides or receives data to or from the main-side transmitting and receiving unit 22. In addition, the copy register management unit 23 controls reading of data from the copy register group 24 and writing of data to the copy register group 24, and manages data stored in the copy register group 24.

The copy register group 24 as one example of a second memory is configured by a memory including plural registers (memory areas). The copy register group 24 of the exemplary embodiment is assumed to include four copy registers (referred to as a first copy register 241 to a fourth copy register 244). Here, memory sizes of the first copy register 241 to the fourth copy register 244 are set to be the same. Note that, the number of the copy registers of the copy register group 24 is not limited to four.

In the exemplary embodiment, the memory contents of control registers of a control register group 34 (which will be described in detail later) in the sub controller 30 are copied to the copy register group 24. Here, the term “copy” indicates processing of reading-out, from the control register group 34, data stored in the control registers, transmitting the read data from the sub controller 30 to the main controller 20 through the transmitting and receiving bus 40, and writing the data received by the main controller 20 to the copy registers of the copy register group 24.

The CPU bus 25 is configured by a parallel bus in which plural signal lines are connected in parallel. This configuration enables parallel communication between the CPU 21 and the main-side transmitting and receiving unit 22 through the CPU bus 25.

(Configuration of Sub Controller)

The sub controller 30 as one example of a first controller includes a sub-side transmitting and receiving unit 32, a control register management unit 33, the control register group 34, and a device driving unit 36. Here, the sub controller 30 of the exemplary embodiment is configured by hardware such as the Application Specific Integrated Circuit (ASIC) or the Field Programmable Gate Array (FPGA), similarly to the aforementioned main controller 20.

The sub-side transmitting and receiving unit 32 is configured by a so-called SERializer/DESerializer (SERDES) functioning as a serializer that converts parallel signals to serial signals and a deserializer that converts serial signals to parallel signals, similarly to the aforementioned main-side transmitting and receiving unit 22. When receiving a packet in serial form from the main controller 20 through the transmitting and receiving bus 40, the sub-side transmitting and receiving unit 32 converts the received packet into a packet in parallel form, decodes the packet in parallel form, and extracts data contained in the packet. In addition, when receiving, from the control register management unit 33, data (parallel signals) to be transmitted to the main controller 20, the sub-side transmitting and receiving unit 32 packetizes the parallel signals, converts the packets into serial form, and transmits the packets to the main controller 20 through the transmitting and receiving bus 40.

The control register management unit 33 as one example of a recognizing unit provides or receives data to or from the sub-side transmitting and receiving unit 32. In addition, the control register management unit 33 controls reading-out of data from the control register group 34, and manages the control register group 34 such that plural blocks set in advance for the control register group 34 are respective units. Here, in the exemplary embodiment, the control register management unit 33 is assumed to recognize the control register group 34 as eight blocks (referred to as a first block B1 to an eighth block B8) into which the control register group 34 is divided. The control register management unit 33 of the exemplary embodiment includes eight management portions (referred to as a first management portion 33A to an eighth management portion 33H) provided so as to correspond to the eight blocks (the first block B1 to the eighth block B8), respectively.

The control register group 34 as one example of a first memory is configured by a memory including plural registers (storage areas).

The control register group 34 of the exemplary embodiment is assumed to include eight control registers (referred to as first to eighth control registers 34A to 34H). Here, the memory sizes of the first control register 34A to the eighth control register 34H are set to be the same. In addition, each of the memory sizes of the first control register 34A to the eighth control register 34H are set to be the same as each of the memory sizes of the first copy register 241 to the fourth copy register 244 of the aforementioned copy register group 24. Note that the number of the control registers of the control register group 34 is not limited to eight. Moreover, the number of the copy registers of the copy register group 24 is set not to be larger than the number of the control registers of the control register group 34. In the exemplary embodiment, the number of the copy registers of the copy register group 24 is four, and is less than eight that is the number of the control registers of the control register group 34.

In the sub controller 30, each control register of the control register group 34 includes an input register and an output register. Here, data indicating the state of the corresponding device of the device group 12 is written to the input register. Data for controlling the corresponding device of the device group 12, which has been transmitted from the CPU 21 of the main controller 20, is written to the output register. Note that, respective pieces of data stored in the first control register 34A to the eighth control register 34H of the control register group 34 are referred to as first data D1 to eighth data D8 in the following description.

The data stored in the control registers of the control register group 34 is copied to the copy register group 24 in the main controller 20 through the transmitting and receiving bus 40, as mentioned above. Thus, the CPU 21 in the main controller 20 reads out the data copied to the copy register group 24 in the main controller 20, and thereby may refer to data same as the data written in the control register group 34 in the sub controller 30. Further, the CPU 21 in the main controller 20 may read out and obtain the data written to the control register group 34 in the sub controller 30, through the transmitting and receiving bus 40.

Note that the control register group 34 includes a register to which data indicating occurrence of an interrupt is written (hereinafter, referred to as an interrupt register) and a register to which data indicating an occurrence factor of an interrupt is written (hereinafter, referred to as an interrupt factor register) (both of which are not shown in the figure).

The device driving unit 36 individually drives the devices of the device group 12 on the basis of the corresponding data written to the output registers of the control registers of the control register group 34. In addition, the device driving unit 36 writes data indicating the state of each device of the device group 12 to the corresponding input register of the control register of the control register group 34. The device driving unit 36 of the exemplary embodiment includes eight driving portions (referred to as a first driving portion 36A to an eighth driving portion 36H) which correspond to the eight devices (the first device 12A to the eighth device 12H) of the device group 12, respectively.

By this configuration, in the sub controller 30 of the exemplary embodiment, the management portions (the first management portion 33A to the eighth management portion 33H) of the control register management unit 33, the control registers (the first control register 34A to the eighth control register 34H) of the control register group 34, and the driving portions (the first driving portion 36A to the eighth driving portion 36H) of the device driving unit 36 correspond to each other one by one. Further, the driving portions (the first driving portion 36A to the eighth driving portion 36H) of the device driving unit 36 correspond to the devices (the first device 12A to the eighth device 12H) of the device group 12 one by one. Thus, in the exemplary embodiment, the control register management unit 33 is configured to conduct management such that one control register (for example, the first control register 34A) correspondingly provided to one device (for example, the first device 12A) is taken as one block (for example, a first block B1). However, the control register management unit 33 is not limited to the above configuration, and may conduct management such that plural (two or more) control registers are taken as one block, for example.

(Configuration of Transmitting and Receiving Bus)

The transmitting and receiving bus 40 of the control device 11 is a transmission path of a full-duplex communication (full duplex) mode, which is configured by a serial bus having a pair of signal lines one of which is for transmission and the other one of which is for reception. The transmitting and receiving bus 40 contains a first signal line Tx which is for transmission of the main controller 20, and a second signal line Rx which is for reception of the main controller 20. This configuration enables serial communication between the main controller 20 and the sub controller 30 through the transmitting and receiving bus 40.

### [Configuration of Main-Side Transmitting and Receiving Unit]

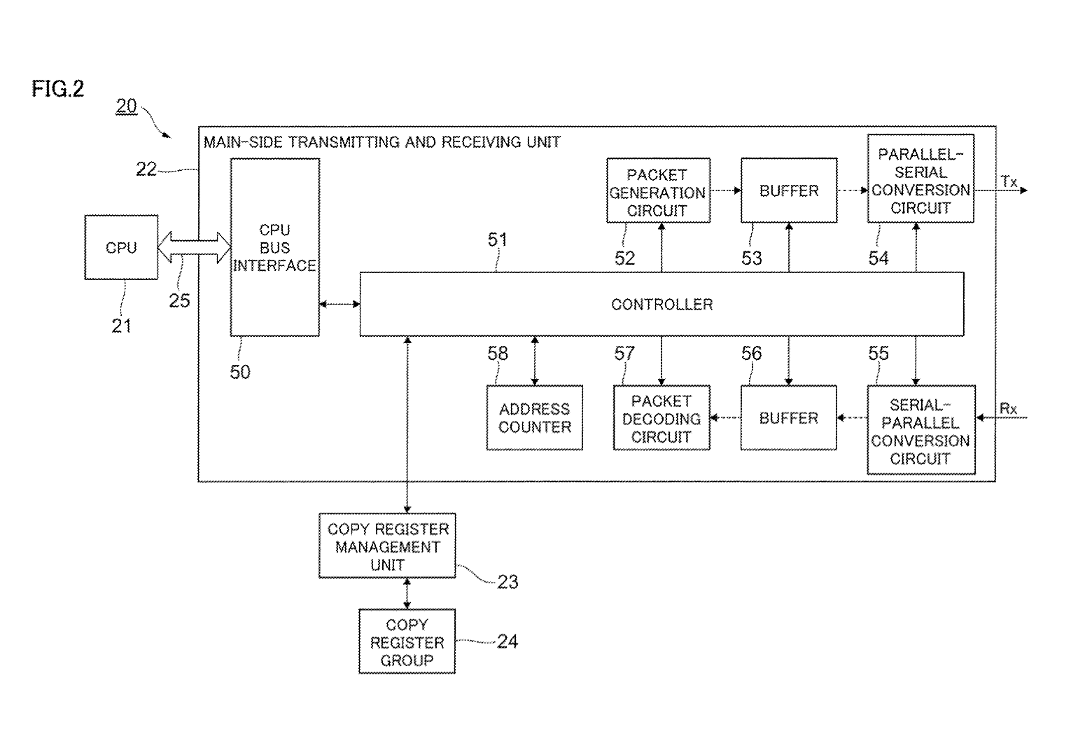

FIG. 2 is a diagram illustrating the configuration of the main-side transmitting and receiving unit 22 in the main controller 20.

The main-side transmitting and receiving unit 22 of the exemplary embodiment includes a CPU bus interface 50, a controller 51, a packet generation circuit 52, a buffer 53, a parallel-serial conversion circuit 54, a serial-parallel conversion circuit 55, a buffer 56, a packet decoding circuit 57, and an address counter 58.

The CPU bus interface 50 performs parallel communication with the CPU 21 through the CPU bus 25.

The controller 51 is connected to each of elements of the main-side transmitting and receiving unit 22, and controls a protocol, operation timing of each element and the like, thereby controlling overall operation of the main-side transmitting and receiving unit 22.

The packet generation circuit 52 converts data on the basis of an instruction received from the CPU 21, and generates a packet in parallel form.

The buffer 53 temporarily stores the packet in parallel form generated by the packet generation circuit 52.

The parallel-serial conversion circuit (serializer) 54 converts the packet in parallel form temporarily stored in the buffer 53 into a packet in serial form, and transmits the packet to the sub controller 30 (refer to FIG. 1) through the first signal line Tx.

The serial-parallel conversion circuit (deserializer) 55 converts a packet in serial form received from the sub controller 30 (refer to FIG. 1) through the second signal line Rx into a packet in parallel form.

The buffer 56 temporarily stores the packet in parallel form obtained by the conversion by the serial-parallel conversion circuit 55.

The packet decoding circuit 57 decodes the packet in parallel form temporarily stored in the buffer 56, and extracts data contained in the packet.

The address counter 58 generates a write destination address used when data having been read from the control register group 34 and then transmitted is written to the copy register group 24, and supplies the write destination address to the copy register management unit 23. The copy register management unit 23 sequentially writes, from the initial address of the copy register group 24, data with the predetermined size, which has been read from the control register group 34 and then transmitted, and thereby copying the data to the copy register group 24 is performed. Thus, every time data with the predetermined size is written to the copy register group 24, the address counter 58 outputs an address which has been increased by a value corresponding to the size. The address counter 58 is reset after writing of all data to the copy register group 24 ends in one start negotiation (which will be described in detail later) and before writing of another data to the copy register group 24 starts in the next starting negotiation (the address counter 58 is set the count value as the initial address).

Here, when the data of the control register group 34 is copied to the copy register group 24, the copy register management unit 23 receives, from the packet decoding circuit 57, the data read and transmitted from one or more control registers of the control register group 34, according to the instruction from the controller 51 in the main-side transmitting and receiving unit 22, and writes the received data to the copy register group 24 according to the address received from the address counter 58, thereby to update the memory contents of the copy register group 24.

Further, when receiving read request to read out data written in the control register group 34 from the CPU 21 through the CPU bus interface 50 and the controller 51, the copy register management unit 23 selects whether to read out the data copied to the copy register group 24 or to directly read out the data written in the control register group 34 on the basis of the read request, performs reading operation, and provides the read data to the CPU 21.

Moreover, when receiving write request to write data to the control register group 34 from the CPU 21 through the CPU bus interface 50 and the controller 51, the copy register management unit 23 selects whether to write data only to the control register group 34 or to directly write data to the copy register group 24 (not update by copying) in addition to the control register group 34 on the basis of the write request, and performs writing operation.

### [Configuration of Sub-Side Transmitting and Receiving Unit]

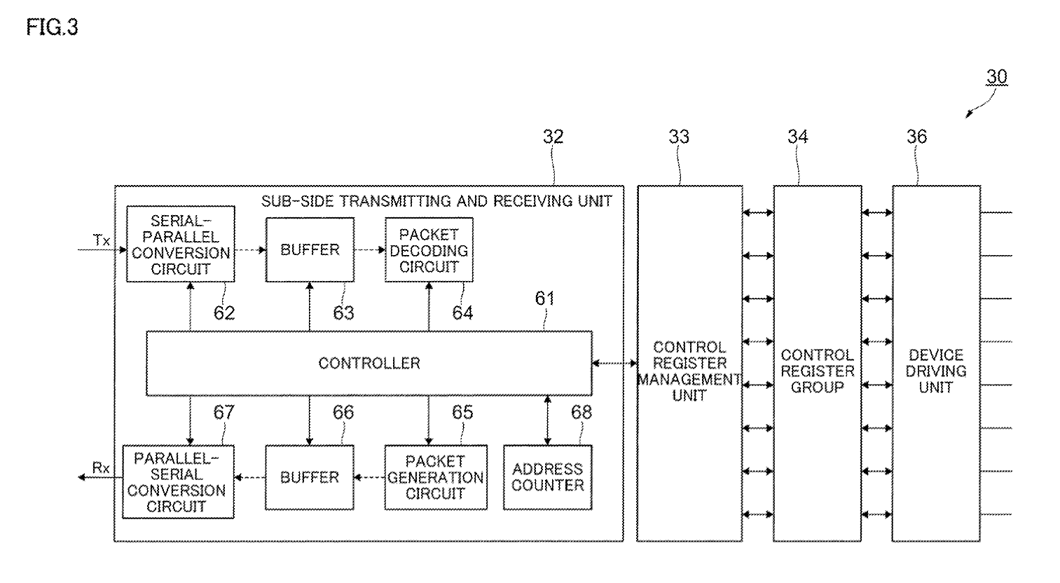

FIG. 3 is a diagram illustrating a configuration of the sub-side transmitting and receiving unit 32 in the sub controller 30.

The sub-side transmitting and receiving unit 32 of the exemplary embodiment includes a controller 61, a serial-parallel conversion circuit 62, a buffer 63, a packet decoding circuit 64, a packet generation circuit 65, a buffer 66, a parallel-serial conversion circuit 67, and an address counter 68.

The controller 61 is connected to other components of the sub-side transmitting and receiving unit 32, and controls a protocol or operation timing of each component, thereby controlling the overall operation of the sub-side transmitting and receiving unit 32.

The serial-parallel conversion circuit 62 converts a packet in serial form which has been received from the main controller 20 (refer to FIG. 1) through the first signal line Tx into a packet in parallel form.

The buffer 63 temporarily stores the packet in parallel form obtained by the conversion by the serial-parallel conversion circuit 62.

The packet decoding circuit 64 decodes the packet in parallel form temporarily stored in the buffer 63, and extracts data contained in the packet.

The packet generation circuit 65 converts the data on the basis of an instruction received from the control register management unit 33, and generates packets in parallel form.

The buffer 66 temporarily stores the packet generated by the packet generation circuit 65.

The parallel-serial conversion circuit 67 converts the packet in parallel form temporarily stored in the buffer 66 into a packet in serial form, and transmits the packet to the main controller 20 (refer to FIG. 1) through the second signal line Rx.

The address counter 68 generates a read source address of data, which is used when data is read from the control register group 34 so as to be copied to the copy register group 24 (refer to FIG. 1), and supplies the read source address to the control register management unit 33. Copying data to the copy register group 24 is performed by reading out data with a predetermined size from the control register group 34 and sequentially transmitting the data to the main controller 20 (refer to FIG. 1). Thus, every time data with the predetermined size is read from the control register group 34, the address counter 68 outputs an address which has been increased by a value corresponding to the size. The address counter 68 is reset when the reading-out of data from the control register group 34 for copy to the copy register group 24 (one block transmission) ends or when the reading-out of the next data from the control register group 34 (next block transmission) starts.

Here, when copying data written in respective registers of the control register group 34 to the copy register group 24, the control register management unit 33 reads out the data from the control register group 34 per block as one unit, supplies the data to the packet generation circuit 65, to generate a packet for writing the data to the copy register group 24 (hereinafter, referred to as a copy command packet). This copy command packet is converted into serial form by the parallel-serial conversion circuit 67, and then transmitted to the main controller 20 (refer to FIG. 1) through the second signal line Rx.

Note that, an interrupt circuit not shown in the figure is provided in the sub controller 30. When an interrupt (for example, abnormal operation of a device of the device group 12) is detected by the interrupt circuit, the controller 61 in the sub-side transmitting and receiving unit 32 writes data indicating occurrence of an interrupt to the interrupt register (not shown in the figure) of the control register group 34, and also writes data indicating an interrupt factor to the interrupt factor register (not shown in the figure). In addition, the controller 61 instructs the packet generation circuit 65 to generate an interrupt packet based on the data indicating the occurrence of the interrupt and the data of the interrupt factor, and the interrupt packet is converted into serial form by the parallel-serial conversion circuit 67, and then transmitted to the main controller 20 (refer to FIG. 1) through the second signal line Rx.

### [Operation of Control Device]

In the exemplary embodiment, the CPU 21 provided in the main controller 20 and controlling overall operation of the image forming apparatus 10 operates on the basis of a system timer. The system timer counts time at a time interval (in a cycle) set in advance, and generates a timer interrupt for the CPU 21 for every count. Updating the system timer (the count of the timer) is performed on the basis of a clock which is supplied from a timer integrated circuit (IC) which is not shown in the figure and is provided on the substrate of the main controller 20. The system timer is a generally known technique in a real-time operating system (OS). Therefore, further description thereof is omitted here.

A timer IC (not shown in the figure) is also provided in the sub controller 30, and outputs a clock in the same cycle as the count cycle of the system timer in the main controller 20.

The CPU 21 in the main controller 20 recognizes states of the devices (the first device 12A to the eighth device 12H) basically on the basis of the corresponding data written to the input registers of the control registers (the first control register 34A to the eighth control register 34H) of the control register group 34 in the sub controller 30 by the device driving unit 36 (the first driving portion 36A to the eighth driving portion 36H). In addition, the CPU 21 in the main controller 20 controls driving of each device through the device driving unit 36 by writing control data to the corresponding output registers of the control registers of the control register group 34 in the sub controller 30.

However, in the exemplary embodiment, data of the control register group 34 in the sub controller 30 is copied to the copy register group 24 in the main controller 20 in a cycle not larger than the cycle of the system timer set in the control device 11. Thus, in order to recognize states and the like of the respective devices connected to the sub controller 30, the CPU 21 in the main controller 20 may read out the data copied to the copy register group 24 in the main controller 20 without obtaining data from the control register group 34 in the sub controller 30 through the transmitting and receiving bus 40, and thereby may recognize the states and the like of the respective devices.

In the exemplary embodiment, in copying data from the control register group 34 in the sub controller 30 to the copy register group 24 in the main controller 20, data stored in all of the control registers of the control register group 34 is not copied to the copy register group 24 in the same order every time, but blocks (control registers) in which data to be copied is stored are designated (selected), and transmitting order of the blocks (control registers) in which data to be copied is stored is designated every time copy operation is performed.

Hereinafter, description will be given for characteristic operation (processing) of the control device 11 in the exemplary embodiment. Note that description for update processing of the control register group 34 in the sub controller 30 (hereinafter, referred to as “update processing of the control register group”) will be given first. Next, description for copy processing from the control register group 34 in the sub controller 30 to the copy register group 24 in the main controller 20 (hereinafter, referred to as “copy processing to the copy register group”) will be given. Finally, description for reading-out processing of data by the CPU 21 in the main controller 20 (hereinafter, referred to as “reading processing of data by the CPU”) will be given.

(Update Processing of Control Register Group)

In the control device 11, the CPU 21 in the main controller 20 makes write request to write control data for controlling the device group 12 to the main-side transmitting and receiving unit 22 through the CPU bus 25. In the write request, data to be written and the address of the register of the control register group 34, which is a destination for the writing, are designated. When receiving the write request through the CPU bus interface 50, the controller 51 of the main-side transmitting and receiving unit 22 controls the packet generation circuit 52, the buffer 53, and the parallel-serial conversion circuit 54 so that the write request received from the CPU 21 is packetized and transmitted to the sub controller 30 through the transmitting and receiving bus 40.

In response to reception of the aforementioned packet by the sub-side transmitting and receiving unit 32 in the sub controller 30 of the control device 11, the controller 61 controls the serial-parallel conversion circuit 62, the buffer 63, and the packet decoding circuit 64 so that the packet of the write request is decoded and the write request is extracted.

Then, the control register management unit 33 writes control data for controlling a device to the corresponding output register of the control register with the address which has been designated in the write request obtained by the aforementioned decode, among plural control registers included in the control register group 34. Then, the device driving unit 36 drives the corresponding device according to the control data written to the output register.

When a signal indicating the state of the connected device is supplied, the device driving unit 36 writes data corresponding to the signal to the input register of the control register corresponding to the device among the plural control registers in the control register group 34.

In this way, the update processing of the control register group 34 is completed.

(Copy Processing to Copy Register Group)

In the control device 11 of the exemplary embodiment, a copy processing is performed in which data of plural blocks designated among all of the data stored in the control register group 34 is read out in the designated order, transmitted through the transmitting and receiving bus 40, and written to the copy register group 24 in a cycle not larger than the count cycle of the system timer. For example, if the count cycle of the system timer is 1 ms, the copy cycle is set to be 1 ms or less. In the exemplary embodiment, the data of the plural blocks designated among the data stored in the control register group 34 is read out in the designated order from the designated first address, plural packets are generated from the read data without designating a copy destination address, and the data is written from the initial address of the copy register group 24 in the transmitting order.

Hereinafter, the copy processing will be described in detail.

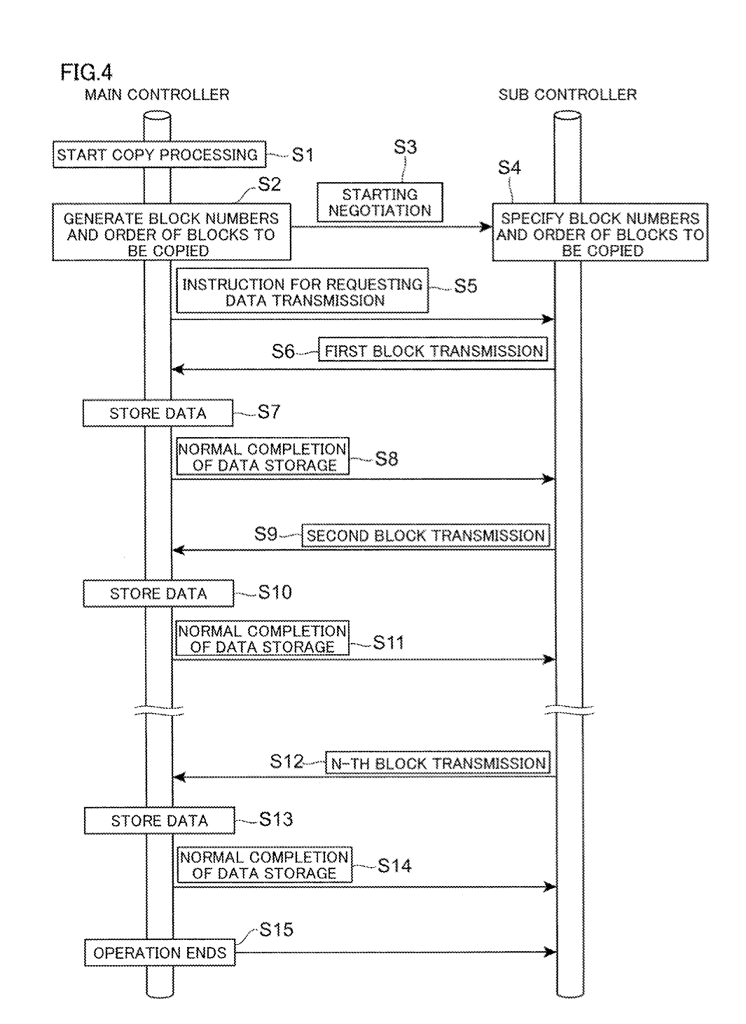

FIG. 4 is a sequence chart for describing the procedure of the copy processing to the copy register group 24.

First, when a clock is output from the timer IC (not shown in the figure) in the main controller 20, the controller 51 in the main-side transmitting and receiving unit 22 of the main controller 20 starts copy processing (step 1). Note that, in this description, although the time when the clock of the timer IC is output is set at a start time of the copy processing, this is only one example, and the start time of the copy processing is not limited to the above.

Next, the controller 51 generates block numbers of blocks to be copied (read out) and the order of the blocks to be copied in the control register group 34 of the sub controller 30, in this copy processing (step 2). Thus, in this example, the copy target contains plural blocks.

Then, the controller 51 performs starting negotiation with the sub controller 30 (step 3).

In step 3, data for copy request containing the block numbers of the blocks to be copied and the order of the blocks, which have been generated in step 2 is firstly supplied from the controller 51 to the packet generation circuit 52. Next, the packet generation circuit 52 generates a packet for copy request (hereinafter, referred to as a copy request packet) from the data for copy request received from the controller 51, and the copy request packet is stored in the buffer 53, under the control of the controller 51. Note that the copy request packet includes data on blocks (the block numbers of the plural blocks to be copied and the order of reading out the blocks) as a source of copy (reading target). Then, the parallel-serial conversion circuit 54 converts the copy request packet (parallel signal) stored in the buffer 53 into a serial signal, and the signal is transmitted to the first signal line Tx, under the control of the controller 51. In this way, the processing at step 3 is completed.

The controller 61 in the sub-side transmitting and receiving unit 32 of the sub controller 30 receives the copy request packet in the starting negotiation from the first signal line Tx in synchronization with the clock output from the timer IC (not shown in the figure) in the sub controller 30. Note that, although the time when the clock of the timer IC is output is set at the start time of receiving the copy request packet, this is only one example, and the start time of receiving the copy request packet is not limited to the above.

Then, the controller 61 analyses the contents of the received copy request packet, and specifies the block numbers of the blocks to be copied (read out) and the order of copying (reading out) the blocks to be copied among the blocks of the control register group 34 in the sub controller 30 (step 4).

In step 4, the serial-parallel conversion circuit 62 firstly converts the copy request packet (serial signal) received from the first signal line Tx into a parallel signal, and the parallel signal is stored in the buffer 63, under the control of the controller 61. Next, the packet decoding circuit 64 decodes the copy request packet stored in the buffer 63, and extracts data on the blocks to be copied, under the control of the controller 61. In this way, the processing at step 4 is completed. Here, the extracted data on the blocks contains the block numbers of the blocks to be copied and the order of the blocks to be copied.

Then, in the main controller 20, the controller 51 in the main-side transmitting and receiving unit 22 transmits an instruction for requesting transmission of data of the blocks to be copied, to the sub controller 30 (step 5).

In the sub controller 30 receiving the instruction for the request at step 5, the control register management unit 33 reads out the data of the control register contained in the block firstly designated in the order on the basis of the block numbers and the order set in step 4, and performs the first block transmission (step 6).

In step 6, the control register management unit 33 firstly reads out the data of the control register contained in the block designated as the first, and supplies the data to the packet generation circuit 65 through the controller 61, under the control of the controller 61 in the sub-side transmitting and receiving unit 32. At this time, the controller 61 sequentially reads out data with the predetermined size for reading-out (for example, a few words) from the block (control register) to be copied in the control register group 34 according to the address output from the address counter 68, and the read data is sequentially supplied to the packet generation circuit 65. Next, the packet generation circuit 65 generates a packet for copy command (hereinafter, referred to as a copy command packet) to write the input data of the block to the copy register group 24 every time the data of the block to be copied is input to the packet generation circuit 65, and the copy command packet is stored in the buffer 66. Note that, the copy command packet does not include information of the address of the copy destination (writing target). Thereby, the amount of the data transmitted from the sub controller 30 to the main controller 20 through the transmitting and receiving bus 40 is reduced. Then, the parallel-serial conversion circuit 67 converts the copy command packet stored in the buffer 66 into a serial signal, and supplies the signal to the second signal line Rx, under the control of the controller 61. In this way, the processing at step 6 is completed. As a result, in step 6, the copy command packets (referred to as a first block transmitting data) containing data of the block designated as the first among all of the data stored in the control register group 34 are generated in the sub controller 30, and then transmitted to the main controller 20.

In the main controller 20 receiving the first block transmission data (copy command packets) in response to the first block transmission at step 6, the copy register management unit 23 stores the data extracted from the first block transmission data that has been received, in the copy register of the copy register group 24 (step 7).

First in step 7, the serial-parallel conversion circuit 55 converts the copy command packets (serial signals) of the first block transmission data received from the second signal line Rx into parallel signals, and the parallel signals are stored in the buffer 56, under the control of the controller 51. Next, the packet decoding circuit 57 decodes the copy command packets stored in the buffer 56 and extracts the data to be copied, under the control of the controller 51. Then, the copy register management unit 23 writes the data obtained by the decode by the packet decoding circuit 57 to the register indicated by the address output from the address counter 58 in the copy register group 24, under the control of the controller 51 in the main-side transmitting and receiving unit 22. In this way, the processing at step 7 is completed.

As the processing at step 7 is normally completed, in the main controller 20, the controller 51 of the main-side transmitting and receiving unit 22 transmits, to the sub controller 30, notification of normal completion of the data storage indicating that the processing at step 7 has been normally completed (step 8).

In the sub controller 30 that has received the notification of the normal completion of the data storage at step 8, the control register management unit 33 reads out the data of the control register contained in the block designated as the second in the order on the basis of the block numbers and the order set at step 4, and performs the second block transmission (step 9). Note that, since step 9 is basically the same as step 6 except that the control register management unit 33 firstly reads out the data of the control register contained in the block set as the second, the detailed description thereof is omitted here. As a result, in step 9, the copy command packets (referred to as the second block transmission data) containing the data of the secondly-designated block among all of the data stored in the control register group 34 are generated in the sub controller 30, and the packets are to be transmitted to the main controller 20.

In the main controller 20 that has received the second block transmission data (copy command packets) in response to the second block transmission at step 9, the copy register management unit 23 stores the data extracted from the received second block transmission data in the copy register of the copy register group 24 (step 10). Note that, since step 10 is basically the same as the aforementioned step 7 except that the serial-parallel conversion circuit 55 firstly converts the copy command packets (serial signal) of the second block transmission data received from the second signal line Rx into parallel signals, the detailed description thereof is omitted here.

As the processing at step 10 is normally completed, in the main controller 20, the controller 51 of the main-side transmitting and receiving unit 22 transmits, to the sub controller 30, notification of normal completion of the data storage indicating that the processing at step 10 has been normally completed (step 11).

Thereafter, transmission of block transmission data from the sub controller 30 to the main controller 20, data storage in the copy register group 24 of the main controller 20, and transmission of notification of normal completion of data storage from the main controller 20 to the sub controller 30 are repeatedly performed the number of times corresponding to the number of the blocks set in the starting negotiation at step 3.

In the sub controller 30 that has received notification of normal completion of the (n−1)-th data storage which is just before the last (in this example, n-th) processing, the control register management unit 33 reads out the data of the control register contained in the block set to be n-th in the order on the basis of the block numbers and the order set at step 4, and performs the n-th block transmission (step 12). Note that, since step 12 is basically the same as the aforementioned step 6 except that the control register management unit 33 firstly reads out the data of the control register contained in the block set to be n-th, the detailed description thereof is omitted here. As a result, in step 12, the copy command packets (referred to as the n-th block transmission data) containing the data of the block designated to be n-th among all of the data stored in the control register group 34 are generated in the sub controller 30, and the packets are to be transmitted to the main controller 20.

In the main controller 20 that has received the n-th block transmission data (copy command packets) in response to the n-th block transmission at step 12, the copy register management unit 23 stores the data extracted from the received n-th block transmission data in the copy register of the copy register group 24 (step 13). Note that, since step 13 is basically the same as the aforementioned step 10 except that the serial-parallel conversion circuit 55 firstly converts the copy command packets (serial signals) of the n-th block transmission data received from the second signal line Rx into parallel signals, the detailed description thereof is omitted here.

As the processing at step 13 is normally completed, in the main controller 20, the controller 51 of the main-side transmitting and receiving unit 22 transmits, to the sub controller 30, data on normal completion of the data storage indicating that the processing at step 13 has been normally completed (step 14). Consequently, along with this transmission, the operation of the first copy processing based on the starting negotiation at step 3 ends (step 15), and thereafter, the second copy processing starts by returning to step 2. The copy processing is repeated until the operation of the control device 11 is stopped (for example, the image forming apparatus 10 is powered off).

Note that, the size of the data to be written to the copy register group 24 at the aforementioned steps 7, 10, and 13 is equal to the read size at reading out the data from the control register group 34. The initial value of the address counter 58 is set to be an initial address of the copy register group 24 (in this example, the initial address of the first copy register 241). Then, every time the copy register management unit 23 writes the data to the copy register group 24, the address counter 58 increases the value corresponding to the aforementioned read size. The copy register management unit 23 repeats the processing in which data is written to the address indicated by the count value of the address counter 58 until all of the data read out and transmitted from the control register group 34 is written.

In the exemplary embodiment, since plural pieces of necessary data are copied to the copy register group 24 by repeating reading of data having the same size from the control register group 34 and writing of the data to the copy register group 24 according to the block numbers and the order which have been designated, copy processing is performed with no problem even if the address of the copy destination (writing destination) is not designated in the copy command packets. By this configuration, the copy processing is simplified.

In the exemplary embodiment, the controller 51 and the controller 61 are configured such that all of the necessary data (in this example, data of the designated plural blocks) is copied to the copy register group 24 in the cycle not larger than the count cycle of the system timer, as mentioned above. That is, the time from the start of the copy of all of the necessary data to the end of the copy of all of the necessary data has the cycle not larger than the count cycle of the system timer. Here, the start of the copy indicates the timing when reading out data for copy from the control register group 34 is started, and the end of the copy indicates the timing when writing all of the necessary data to the copy register group 24 ends. Thus, if data in the control register group 34 is updated in the middle of a count cycle, the updated data is copied to the copy register group 24 in the next count cycle at the latest. The CPU 21 may refer to the data updated in a cycle not larger than the count cycle of the system timer if referring to the data copied to the copy register group 24. Note that the copy cycle is set in advance.

The copy command packets generated from the data in the control register group 34 are transmitted one by one at intervals not less than a predetermined time (although the time from start to end of copy is not larger than the count cycle of the system timer). Thus, even if an interrupt occurs during transmission processing of copy command packets, an interrupt packet may be transmitted from the sub controller 30 to the main controller 20 after the transmission of a copy command packet and before transmission of the next copy command packet. If no interrupt packet is transmitted, copy command packets may be transmitted at intervals set to be narrower (that is, set to be shorter than in the case where an interrupt packet is issued).

(Data Reading Processing by CPU)

In the control device 11, when intending to refer to data written to the control register group 34 in the sub controller 30, the CPU 21 in the main controller 20 reads out data from the copy register group 24 instead of directly obtaining data from the control register group 34, and thereby refers to the data written in the control register group 34 in the exemplary embodiment.

To read out data, the CPU 21 makes read request in which the address in the control register group 34 is designated, to the main-side transmitting and receiving unit 22. When obtaining, from the CPU 21, read request to read out data in the control register group 34, the controller 51 of the main-side transmitting and receiving unit 22 inquires, of the copy register group 24, whether the target data for the read request is stored in the copy register group 24. In the case where the target data for the read request is stored in the copy register group 24, the controller 51 reads out the data corresponding to the address designated by the read request from the copy register of the copy register group 24 through the copy register management unit 23, and supplies the data to the CPU 21. At this time, no packet of the read request is issued for the control register group 34. On the other hand, in the case where the target data for the read request is not stored in the copy register group 24, the controller 51 issues a packet of the read request for the control register group 34, and transmits the packet to the sub controller 30. Then, in the sub controller 30, the controller 61 of the sub-side transmitting and receiving unit 32 reads out the data with the address designated in the read request from the control register of the control register group 34 through the control register management unit 33, and supplies the data to the CPU 21 of the main controller 20.

### [Specific Example of Copy Processing to Copy Register Group]

Description will be given for the copy processing to the copy register group 24 shown in the aforementioned FIG. 4, with a specific example.

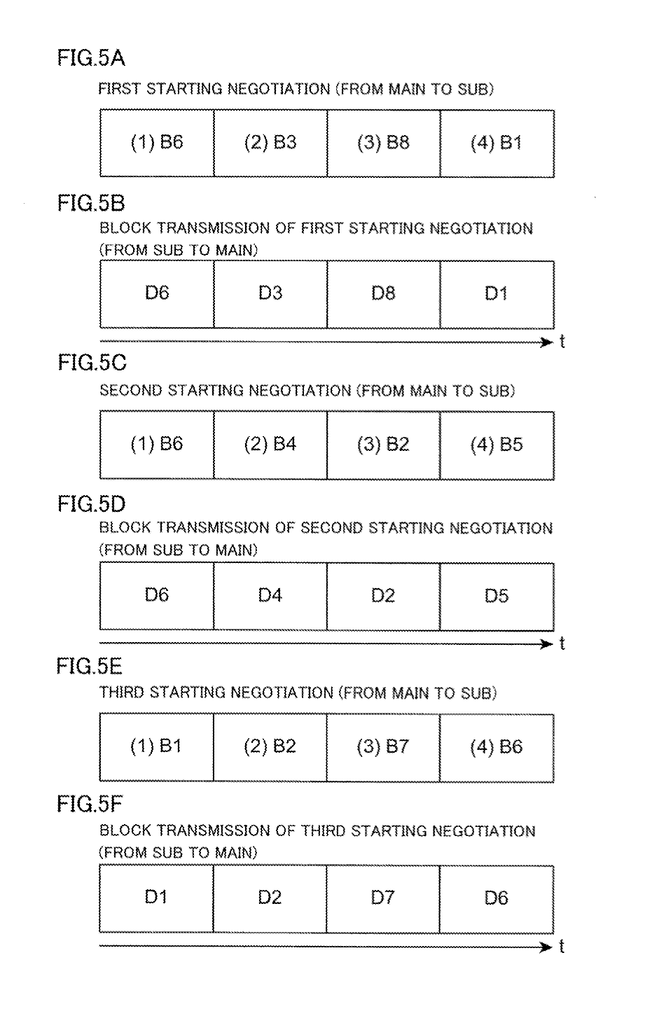

FIGS. 5A to 5F are diagrams illustrating one example of data supply and data reception between the main controller 20 and the sub controller 30 in the copy processing to the copy register group 24. Note that description is given for the case where starting negotiation is repeated three times in the copy processing shown in FIG. 4, as an example. In addition, the description is given for the case where four blocks are designated as targets for copy in one starting negotiation (copy request packet), as an example.

FIG. 5A illustrates, as an example, a copy request packet that is to be transmitted from the main controller 20 to the sub controller 30 in the first starting negotiation. In this example, the sixth block B6 is designated as the first (1), the third block B3 is designated as the second (2), the eighth block B8 is designated as the third (3), and the first block B1 is designated as the fourth (4) in the copy request packet of the first starting negotiation.

FIG. 5B illustrates, as an example, the block transmission data (copy command packets) to be transmitted from the sub controller 30 to the main controller 20 in the first starting negotiation on the basis of the copy request packet shown in FIG. 5A. In this example, the sixth data D6 read out from the sixth block B6 (in this example, the sixth control register 34F) is disposed first, the third data D3 read out from the third block B3 (in this example, the third control register 34C) is disposed second, the eighth data D8 read out from the eighth block B8 (in this example, the eighth control register 34H) is disposed third, and the first data D1 read out from the first block B1 (in this example, the first control register 34A) is disposed fourth, so as to correspond to the copy request packet shown in FIG. 5A. As a result, the copy command packets are configured to be output in this order (D6->D3->D8->D1) along the elapse of time t.

FIG. 5C illustrates, as an example, a copy request packet that is to be transmitted from the main controller 20 to the sub controller 30 in the second starting negotiation subsequent to the first one. In this example, the sixth block B6 is designated as the first (1), the fourth block B4 is designated as the second (2), the second block B2 is designated as the third (3), and the fifth block B5 is designated as the fourth (4) in the copy request packet of the second starting negotiation.

FIG. 5D illustrates, as an example, the block transmission data (copy command packets) to be transmitted from the sub controller 30 to the main controller 20 in the second starting negotiation on the basis of the copy request packet shown in FIG. 5C. In this example, the sixth data D6 read out from the sixth block B6 (in this example, the sixth control register 34F) is disposed first, the fourth data D4 read out from the fourth block B4 (in this example, the fourth control register 34D) is disposed second, the second data D2 read out from the second block B2 (in this example, the second control register 34B) is disposed third, and the fifth data D5 read out from the fifth block B5 (in this example, the fifth control register 34E) is disposed fourth, so as to correspond to the copy request packet shown in FIG. 5C. As a result, the copy command packets are configured to be output in this order (D6->D4->D2->D5) along the elapse of time t.

FIG. 5E illustrates, as an example, a copy request packet that is to be transmitted from the main controller 20 to the sub controller 30 in the third starting negotiation subsequent to the second one. In this example, the first block B1 is designated as the first (1), the second block B2 is designated as the second (2), the seventh block B7 is designated as the third (3), and the sixth block B6 is designated as the fourth (4) in the copy request packet of the third starting negotiation.

FIG. 5F illustrates, as an example, the block transmission data (copy command packets) to be transmitted from the sub controller 30 to the main controller 20 in the third starting negotiation on the basis of the copy request packet shown in FIG. 5E. In this example, the first data D1 read out from the first block B1 (in this example, the first control register 34A) is disposed first, the second data D2 read out from the second block B2 (in this example, the second control register 34B) is disposed second, the seventh data D7 read out from the seventh block B7 (in this example, the seventh control register 34G) is disposed third, and the sixth data D6 read out from the sixth block B6 (in this example, the sixth control register 34F) is disposed fourth, so as to correspond to the copy request packet shown in FIG. 5E. As a result, the copy command packets are configured to output in this order (D1->D2->D7->D6) along the elapse of time t.

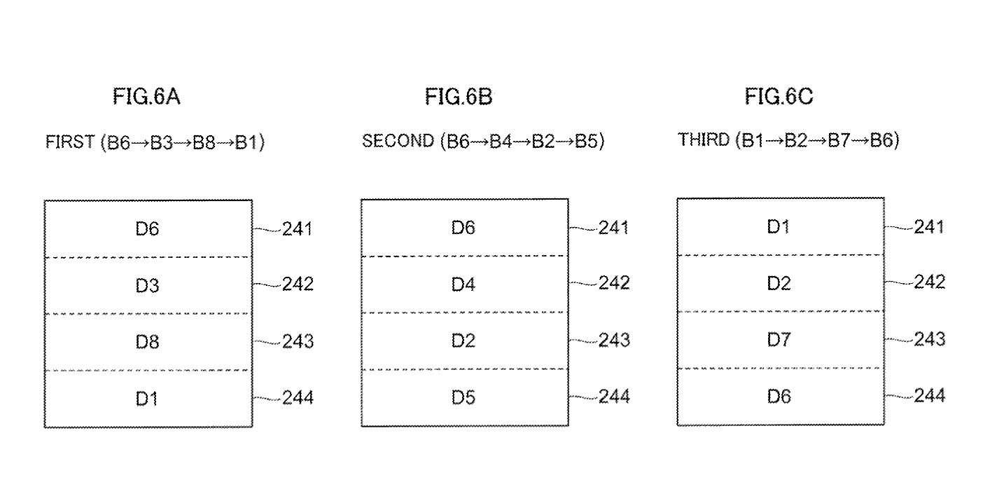

FIGS. 6A to 6C are diagrams illustrating transition of the memory contents of the copy register group 24 in the main controller 20, as an example of the copy processing shown in FIGS. 5A to 5F.

FIG. 6A illustrates the memory contents of the copy register group 24 stored on the basis of the block transmission data (copy command packets) in the first starting negotiation shown in FIG. 5B. In this example, the sixth data D6 disposed first in the copy command packets is stored in the first copy register 241 that is the first target storage in the copy register group 24, the third data D3 disposed second in the copy command packets is stored in the second copy register 242 that is the second target storage in the copy register group 24, the eighth data D8 disposed third in the copy command packets is stored in the third copy register 243 that is the third target storage in the copy register group 24, and the first data D1 disposed fourth in the copy command packets is stored in the fourth copy register 244 that is the fourth target storage in the copy register group 24, so as to correspond to the copy command packets shown in FIG. 5B. At this time, data is configured to be stored in the copy register group 24, in the aforementioned order (D6->D3->D8->D1).

FIG. 6B illustrates the memory contents of the copy register group 24 stored on the basis of the block transmission data (copy command packets) in the second start negotiation shown in FIG. 5D. In this example, the sixth data D6 disposed first in the copy command packets is stored in the first copy register 241 that is the first target storage in the copy register group 24, the fourth data D4 disposed second in the copy command packets is stored in the second copy register 242 that is the second target storage in the copy register group 24, the second data D2 disposed third in the copy command packets is stored in the third copy register 243 that is the third target storage in the copy register group 24, and the fifth data D5 disposed fourth in the copy command packets is stored in the fourth copy register 244 that is the fourth target storage in the copy register group 24, so as to correspond to the copy command packets shown in FIG. 5D. At this time, data is configured to be stored in the copy register group 24, in the aforementioned order (D6->D4->D2->D5).

FIG. 6C illustrates the memory contents of the copy register group 24 stored on the basis of the block transmission data (copy command packets) in the third starting negotiation shown in FIG. 5F. In this example, the first data D1 disposed first in the copy command packets is stored in the first copy register 241 that is the first target storage in the copy register group 24, the second data D2 disposed second in the copy command packets is stored in the second copy register 242 that is the second target storage in the copy register group 24, the seventh data D7 disposed third in the copy command packets is stored in the third copy register 243 that is the third target storage in the copy register group 24, and the sixth data D6 disposed fourth in the copy command packets is stored in the fourth copy register 244 that is the fourth target storage in the copy register group 24, so as to correspond to the copy command packets shown in FIG. 5F. At this time, data is configured to be stored in the copy register group 24, in the aforementioned order (D1->D2->D7->D6).

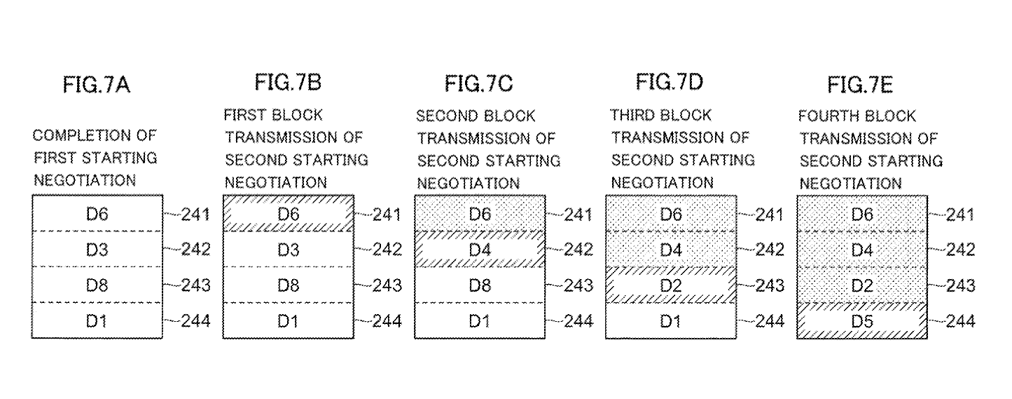

FIGS. 7A to 7E are diagrams illustrating transition of the memory contents of the copy register group 24 from the time after the data storage on the basis of the block transmission data in the first starting negotiation (refer to FIG. 6A) to the time after the data storage on the basis of the block transmission data in the second starting negotiation (refer to FIG. 6B), in one example of the copy processing shown in FIGS. 5A to 5F.

FIG. 7A illustrates the memory contents of the copy register group 24 stored on the basis of the first start negotiation shown in FIG. 5B. Note that, since the contents shown in FIG. 7A are the same as those shown in the aforementioned FIG. 6A, the detailed description thereof is omitted here.

FIG. 7B illustrates the memory contents of the copy register group 24 in which overwrite processing has been performed on the first copy register 241 on the basis of the first block transmission data (copy command packets) of the second starting negotiation shown in FIG. 5D. At this time, in the copy register group 24, while the memory content of the first copy register 241 is updated so that the sixth data D6 is replaced with the new sixth data D6, the memory contents of the second copy register 242 to the fourth copy register 244 are maintained in the previous state shown in FIG. 7A.

In this example, the memory content of the first copy register 241 is updated so that the sixth data D6 is replaced with the new sixth data D6. Here, since the respective contents of the first data D1 to the eighth data D8 are sequentially updated in the exemplary embodiment, it makes sense to overwrite, to the same copy register, data with data read out from the same control register.

FIG. 7C illustrates the memory contents of the copy register group 24 in which overwrite processing has been performed on the second copy register 242 from the state shown in FIG. 7B on the basis of the second block transmission data (copy command packets) of the second starting negotiation shown in FIG. 5D. At this time, in the copy register group 24, while the memory content of the second copy register 242 is updated so that the third data D3 is replaced with the fourth data D4, the memory content of the first copy register 241 is maintained in the overwritten state shown in FIG. 7B and the memory contents of the third copy register 243 and the fourth copy register 244 are maintained in the previous state shown in FIG. 7A.

FIG. 7D illustrates the memory contents of the copy register group 24 in which overwrite processing has been performed on the third copy register 243 from the state shown in FIG. 7C on the basis of the third block transmission data (copy command packets) of the second starting negotiation shown in FIG. 5D. At this time, in the copy register group 24, while the memory content of the third copy register 243 is updated so that the eighth data D8 is replaced with the second data D2, the memory contents of the first copy register 241 and the second copy register 242 are maintained in the overwritten state shown in FIG. 7C and the memory content of the fourth copy register 244 is maintained in the previous state shown in FIG. 7A.

FIG. 7E illustrates the memory contents of the copy register group 24 in which overwrite processing has been performed on the fourth copy register 244 from the state shown in FIG. 7D on the basis of the fourth block transmission data (copy command packets) of the second starting negotiation shown in FIG. 5D. At this time, in the copy register group 24, while the memory content of the fourth copy register 244 is updated so that the first data D1 is replaced with fifth data D5, the memory contents of the first copy register 241 to the third copy register 243 are maintained in the overwritten state shown in FIG. 7D. Note that the contents shown in FIG. 7E are the same as those shown in FIG. 6B.

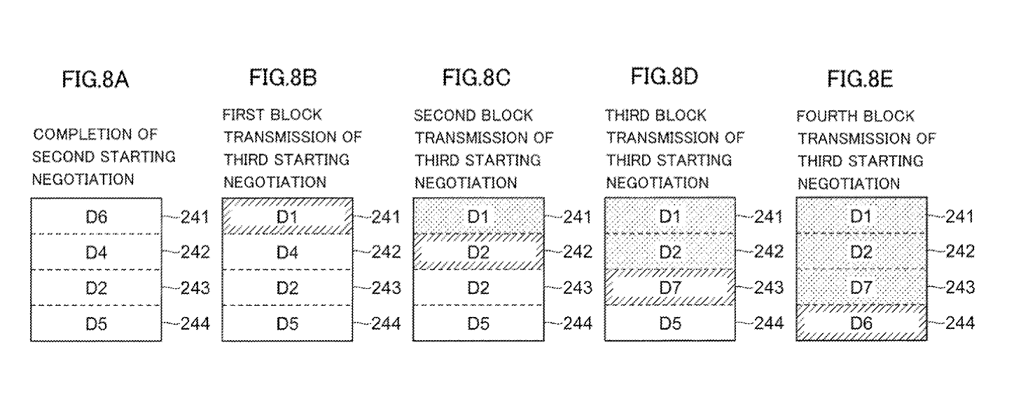

FIGS. 8A to 8E are diagrams illustrating transition of the memory contents of the copy register group 24 from the time after the data storage on the basis of the second starting negotiation (refer to FIG. 6B) to the time after the data storage on the basis of the third starting negotiation (refer to FIG. 6C), in one example of the copy processing shown in FIGS. 5A to 5F.

FIG. 8A illustrates the memory contents of the copy register group 24 stored on the basis of the second block transmission data (copy command packets) shown in FIG. 5D. Note that, since the contents shown in FIG. 8A are the same as those shown in each of the aforementioned FIGS. 6B and 7E, the detailed description thereof is omitted here.

FIG. 8B illustrates the memory contents of the copy register group 24 in which overwrite processing has been performed on the first copy register 241 from the state shown in FIG. 8A on the basis of the first block transmission data (copy command packets) of the third starting negotiation shown in FIG. 5F. At this time, in the copy register group 24, while the memory content of the first copy register 241 is updated so that the sixth data D6 is replaced with the first data D1, the memory contents of the second copy register 242 to the fourth copy register 244 are maintained in the previous state shown in FIG. 8A.

FIG. 8C illustrates the memory contents of the copy register group 24 in which overwrite processing has been performed on the second copy register 242 from the state shown in FIG. 8B on the basis of the second block transmission data (copy command packets) of the third starting negotiation shown in FIG. 5F. At this time, in the copy register group 24, while the memory content of the second copy register 242 is updated so that the fourth data D4 is replaced with the second data D2, the memory content of the first copy register 241 is maintained in the overwritten state shown in FIG. 8B and the memory contents of the third copy register 243 and the fourth copy register 244 are maintained in the previous state shown in FIG. 8A.

In this example, the second data D2 is stored in the second copy register 242 as well as the third copy register 243 in the state shown in FIG. 8C. Here, since the respective contents of the first data D1 to the eighth data D8 are sequentially updated as mentioned above in the exemplary embodiment, it makes sense to write data read from the same control register to different copy registers at different timing.

FIG. 8D illustrates the memory contents of the copy register group 24 in which overwrite processing has been performed on the third copy register 243 from the state shown in FIG. 8C on the basis of the third block transmission data (copy command packets) of the third starting negotiation shown in FIG. 5F. At this time, in the copy register group 24, while the memory content of the third copy register 243 is updated so that the second data D2 is replaced with the seventh data D7, the memory contents of the first copy register 241 and the second copy register 242 are maintained in the overwritten state shown in FIG. 8C and the memory content of the fourth copy register 244 is maintained in the previous state shown in FIG. 8A.

FIG. 8E illustrates the memory contents of the copy register group 24 in which overwrite processing has been performed on the fourth copy register 244 from the state shown in FIG. 8D on the basis of the fourth block transmission data (copy command packets) of the third starting negotiation shown in FIG. 5F. At this time, in the copy register group 24, while the memory content of the fourth copy register 244 is updated so that the fifth data D5 is replaced with the sixth data D6, the memory contents of the first copy register 241 to the third copy register 243 are maintained in the overwritten state shown in FIG. 8D. Note that the contents shown in FIG. 8E are the same as those shown in FIG. 6C.

Note that, in the exemplary embodiment, four blocks less than the eight blocks set in the sub controller 30 are selected in generating a copy request packet in the main controller 20. However, the selection is not limited to the above. For example, all (eight) blocks may be designated and the order of these eight blocks may be designated in generating a copy request packet. In this case, the sub controller 30 that has received the copy request packet generates block transmission data (copy command packets) of the eight blocks disposed in chronological order according to the designated order, and transmits the data to the main controller 20.

In addition, in the exemplary embodiment, the order of the designated plural blocks is set in generating a copy request packet in the main controller 20. However, the order is not limited to the above. For example, plural (for example, four) blocks may be selected among all (eight) blocks set in the sub controller 30 and no order may be set for the selected plural blocks in generating a copy request packet. In this case, the sub controller 30 that has received the copy request packet generates block transmission data (copy command packets) of the plural blocks disposed in chronological order according to the ascending order of the block numbers, and transmits the data to the main controller 20.

Moreover, in the exemplary embodiment, blocks the number of which is always the same (here, four) are selected from among the eight blocks set in the sub controller 30 in generating a copy request packet in the main controller 20. However, the number is not limited to the above. For example, the number of blocks to be selected may be changed (selected from among 1 to 8) in generating a copy request packet. In this case, the sub controller 30 that has received the copy request packet generates block transmission data (copy command packets) of the blocks disposed in chronological order, the number of the blocks having been selected, and transmits the data to the main controller 20.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control device comprising:
a first controller that includes a first memory configured to store data on control of a plurality of devices connected to the first controller, and a recognizing unit configured to recognize the first memory as a plurality of blocks each of which contains data of at least one of the plurality of devices; and
a second controller that includes a processing unit configured to perform processing for controlling the plurality of devices, a requesting unit configured to designate a block for the first controller and request the first controller to read data, and a second memory configured to store the data of the block, the data being received from the first controller.

2. The control device according to claim 1, wherein the requesting unit designates one or more blocks less than the plurality of blocks, from among the plurality of blocks recognized by the recognizing unit.

3. The control device according to claim 1, wherein the requesting unit designates order of reading data for the plurality of blocks recognized by the recognizing unit.

4. The control device according to claim 2, wherein the requesting unit designates order of reading data for the plurality of blocks recognized by the recognizing unit.

5. An image forming apparatus comprising:
a plurality of devices that are used in image forming operation in which an image is formed on a recording medium; and
a control device that controls the plurality of devices, wherein
the control device comprises:
a first controller that includes a first memory configured to store data on control of the plurality of devices connected to the first controller, and a recognizing unit configured to recognize the first memory as a plurality of blocks each of which contains data of at least one of the plurality of devices; and
a second controller that includes a processing unit configured to perform processing for controlling the plurality of devices, a requesting unit configured to designate a block for the first controller and request the first controller to read data, and a second memory configured to store the data of the block, the data being received from the first controller.

6. A control method comprising:
recognizing, in a first controller, a first memory that is provided in the first controller and configured to store data on control of a plurality of devices connected to the first controller, as a plurality of blocks each of which contains data of at least one of the plurality of devices; and
performing processing for controlling the plurality of devices in a second controller connected to the first controller, designating a block for the first controller and requesting the first controller to read data, and making the data of the block stored in a second memory provided in the second controller, the data of the block being received from the first controller.
